(19) United States
(12) Patent Application Publication
(10) Pub. No.: US 2016/0179218 A1
(43) Pub. Date: Jun. 23, 2016

(54) SYSTEMS AND METHODS FOR IMPROVING THE QUALITY OF MOTION SENSOR GENERATED USER INPUT TO MOBILE DEVICES

(71) Applicant: Intel Corporation, Santa Clara, CA (US)

(72) Inventor: JOEL B. ROSENZWEIG, Marlborough, MA (US)

(21) Appl. No.: 14/580,374

(22) Filed: Dec. 23, 2014

(51) Int. Cl. G06F 3/0346; G09G 5/00; G01C 23/00

(52) U.S. Cl. CPC G06F 3/0346; G01C 23/00; G09G 5/003; G09G 2370/00

(57) ABSTRACT

Systems and methods are disclosed for improving user input to a mobile device. A remote motion sensor device is configured to generate remote acceleration data corresponding to movement of a vehicle. An accelerometer module is configured to receive the remote acceleration data generated by the remote motion sensor, receive local acceleration data corresponding to movement of the mobile device, subtract the remote acceleration data from the local acceleration data to generate compensated acceleration data, and provide the compensated acceleration data as user input to a software application on the mobile device.

### TECHNICAL FIELD

This disclosure generally relates to mobile devices, and more particularly to improving the quality of accelerometer and/or other motion sensor generated user input to mobile devices while the user and device are both moving.

### BACKGROUND

Playing video games on mobile devices while sitting in a moving vehicle (e.g., car, bus, train, airplane, boat, etc.) is an unpredictable experience because every acceleration that the vehicle makes imparts unintended acceleration input data to the application running on the mobile device. The mobile device cannot differentiate between intended acceleration (e.g., the player intended to tilt the phone to provide input to a software application) versus unintended acceleration (e.g., the moving vehicle turned or went over a bump in the road). These unintended accelerations due to operating in the context of a moving vehicle are “noise” that are transmitted to the mobile device via the user. Such noise may negatively impact the operation or accuracy of the software application (e.g., a game) running on the mobile device.

### BRIEF DESCRIPTION OF THE DRAWINGS

FIG. 1 is a block diagram of a system for improving the quality of accelerometer generated user input to a mobile device according to one embodiment.

FIG. 2 illustrates an example interior region of a vehicle with a mobile device and a remote motion sensor device according to one embodiment.

FIG. 3A illustrates a handheld computer (e.g., tablet) configured to receive user input through movement of a user's hands according to one embodiment.

FIG. 3B illustrates virtual reality goggles configured to receive user input through movement of a user's head according to one embodiment.

FIG. 4 is a block diagram of a remote motion sensor device according to one embodiment.

FIG. 5A is a block diagram of a motion sensor module according to one embodiment.

FIG. 5B is a block diagram of a motion sensor module according to another embodiment.

FIG. 6 is a block diagram of an accelerometer module according to one embodiment.

FIG. 7 is a block diagram of a motion compensation module according to one embodiment.

FIG. 8 is an example illustration of a mobile device that may be used according to certain embodiments.

FIG. 9 is a flowchart of a method for controlling a user application on a mobile device according to one embodiment.

### DETAILED DESCRIPTION OF EMBODIMENTS

Advances in motion sensor technologies have provided for new forms of interaction between users and handheld computers or mobile devices (e.g., mobile phones, tablets, personal digital assistants, handheld video game consoles, wearable computing devices, virtual reality helmets, etc.). In particular, user input may be in the form of movement of the handheld computer. For example, a user may tilt, turn, rotate, or shake a mobile device to control actions or movement of a character in a video game, scroll through a document, open or close a software application, select a function of a software application, or provide other types of user input. As discussed above, when a user does not have control of the surrounding environment, such as when the user is a passenger in a moving vehicle, unintended accelerations on the user may cause unintended user input to the mobile device.

In certain embodiments disclosed herein, an accelerometer is mounted to a moving vehicle to provide (e.g., wirelessly or through a communication cable) a data stream that the mobile device can use to cancel out unwanted or unintended acceleration due to the moving vehicle. Because the moving vehicle and the mobile device undergo approximately the same accelerations in each axis, the mobile device is configured to exploit the differential nature of the signal to subtract the noise (the data from the remotely mounted accelerometer) from the mobile device's accelerometer signal (the data that the mobile device presents in its unfiltered data stream). The resulting signal has less noise than that of the uncompensated motion signal. Thus, the sensor driver on the mobile device presents software applications with a data stream that more accurately reflects what the user intended, e.g., as if the user and the device were not undergoing unintended acceleration. The user's experience (e.g., game play or other interaction with the mobile device) is improved due to the enhanced noise immunity derived from the use of the differential signal.

In certain embodiments, a peripheral device includes a system on chip (SoC), a communication interface, and a 3-axis accelerometer. The peripheral device, also referred to herein as a remote motion sensor device, may be either permanently or temporarily mounted to a fixed location on a moving vehicle. The peripheral device constantly communicates 3-axis accelerometer data to a driver or module residing on a mobile device connected through the communication interface. In one embodiment, the communication interface is a wireless communication interface, such as a Bluetooth or WiFi (under the Institute of Electrical and Electronics Engineers (IEEE) 802.11 standard) radio communications subsystem. Thus, the peripheral device may be paired with one or more handheld mobile devices that are granted access to the 3-axis accelerometer data. In addition, or in other embodiments, the peripheral device may be tethered to a mobile device via a cable plugged into an available auxiliary port on the mobile device. While a wireless link may provide a higher level of convenience, embodiments that include only the tethered option provide a lower cost and lower power alternative due to the removal of the radio communications subsystem.

In certain embodiments, a mobile device includes a driver or module for the remote motion sensor device that is configured to receive a data stream including 3-axis acceleration data from a remote sensor, and to provide the data stream to a replacement accelerometer driver. The replacement accelerometer driver is configured to subtract the remote sensor waveform data from the local sensor waveform data through, for example, the use of digital audio signal processing techniques. The waveform subtraction process yields motion compensated user input data to a software application running on the mobile device. In certain embodiments, the replacement accelerometer driver interfaces with the mobile device system using the same application programming interface definition as that of an original accelerometer driver on the mobile device, which enables seamless integration into the underlying system software of the mobile device. Thus, the new accelerometer driver can replace the old accelerometer driver without the need to modify or notify the software application running on the mobile device that receives the motion compensated user input data. Such embodiments provide a minimally invasive change to the software environment of the mobile device.

Example embodiments are described below with reference to the accompanying drawings. Many different forms and embodiments are possible without deviating from the spirit and teachings of the invention and so the disclosure should not be construed as limited to the example embodiments set forth herein. Rather, these example embodiments are provided so that this disclosure will be thorough and complete, and will convey the scope of the invention to those skilled in the art. In the drawings, the sizes and relative sizes of components may be exaggerated for clarity. The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween.

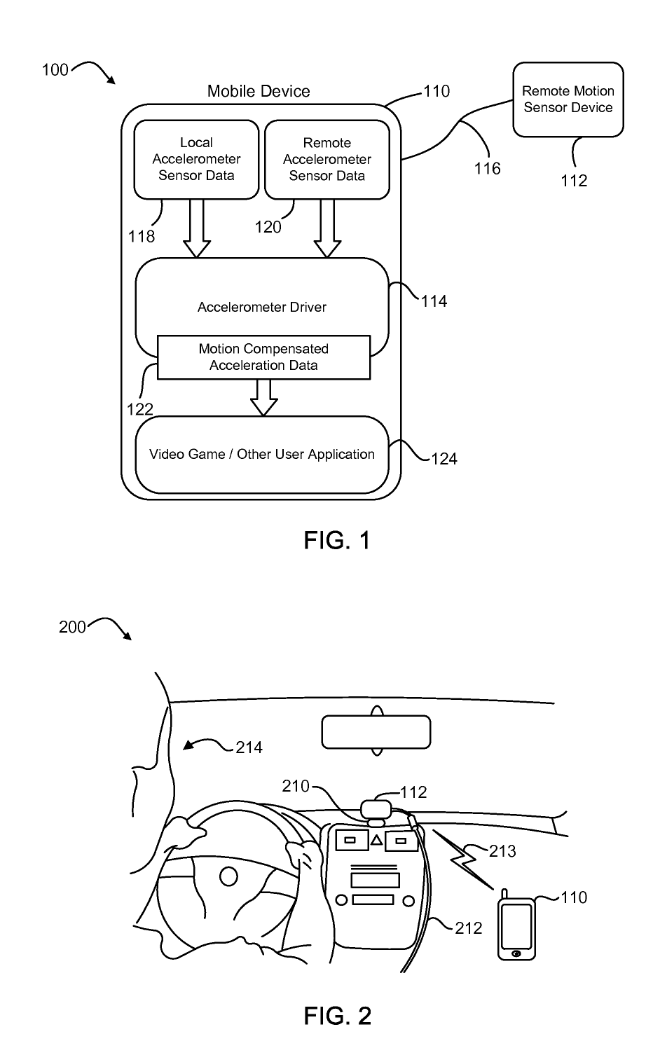

FIG. 1 is a block diagram of a system 100 for improving the quality of accelerometer generated user input to a mobile device 110 according to one embodiment. The system 100 includes a remote motion sensor device 112 and an accelerometer driver 114. In certain embodiments, the remote motion sensor device 112 comprises a portable motion sensor device. The remote motion sensor device 112 is configured to generate 3-axis accelerometer data and to communicate the 3-axis accelerometer data to the mobile device 110. Skilled persons will recognize from the disclosure herein that in other embodiments the remote motion sensor device 112 generates 2-axis accelerometer data, or even single-axis accelerometer data. As shown in FIG. 1, the remote motion sensor device 112 may communicate the accelerometer data to the mobile device 110 through a communication cable 116. In other embodiments, however, the remote motion sensor device 112 communicates wirelessly with the mobile device 110.

The mobile device 110 comprises the accelerometer driver 114. Although not shown in FIG. 1, the mobile device 110 also comprises one or more motion sensors including a 3-axis accelerometer. The one or more motion sensors of the mobile device 110 may also include a gyroscope and a magnetometer. The accelerometer driver 114 is configured to receive local accelerometer sensor data 118 from the one or more motion sensors of the mobile device 110 and remote accelerometer sensor data from the remote motion sensor device 112. The accelerometer driver 114 is also configured to subtract the remote accelerometer sensor data 120 from the local accelerometer sensor data 118 through, for example, the use of digital audio signal processing techniques. The subtraction process yields motion compensated acceleration data 122 to a video game or other software application 124 running on the mobile device 110.

FIG. 2 illustrates an example interior region of a vehicle 200 with a mobile device 110 and a remote motion sensor device 112 according to one embodiment. In this example, the remote motion sensor device 112 is attached by mount 210 to the interior of the vehicle 200, is powered through a power cable 212 electrically coupled to the vehicle's power system, and is configured to communicate wirelessly with the mobile device 110 (as indicated by wireless signal 213). The mount 210 may be any type of coupling mechanism to permanently or temporarily attach the remote motion device 112 to the vehicle 200. For example, the mount 210 may include a magnet to attach to a magnetic surface of the vehicle 200, or a clamp or protruding member that attaches to an air movement grill of the vehicle 200. In other examples, the mount 210 can include a plate or other type of member configured to be fastened to any surface of the vehicle 200 using any type of fastener (e.g., screws, clamps, a Velcro coupling mechanism, a sliding coupling mechanism, a snapping coupling mechanism, a suction cup coupling mechanism, etc.). In still other examples, the mount 210 can merely sit on a generally horizontal surface of the interior region of the vehicle 200, such as on the top of the dashboard, without being fastened to that surface. To reduce the risk of this type of mount sliding on the surface during movement of the vehicle 200, it can include a weighted member, such as a sand-filled malleable base member.

In the example of FIG. 2, the vehicle 200 is an automobile (e.g., car or truck). However, the embodiments disclosed herein may be used with any type of vehicle or machine including, by way of example only and not by limitation, bus, train, airplane, boat, vehicle simulator, amusement ride, virtual reality environment, or any other machine, system or environment configured to impart movement to a user and/or a mobile device. As shown, while the vehicle 200 is in motion, the remote motion sensor device 112 may be accessible to users such as a driver 214 and/or a passenger (not shown). In other embodiments, the remote motion sensor device 112 may be located on an exterior surface of the vehicle 200, or in an interior portion of the vehicle 200 that may be inaccessible during vehicle operation, such as in an engine compartment, trunk, or other storage compartment. For safety reasons, it may be desirable for a user such as a passenger (rather than the driver 214 shown in FIG. 2) to provide input to the mobile device 110 during operation of the vehicle 200.

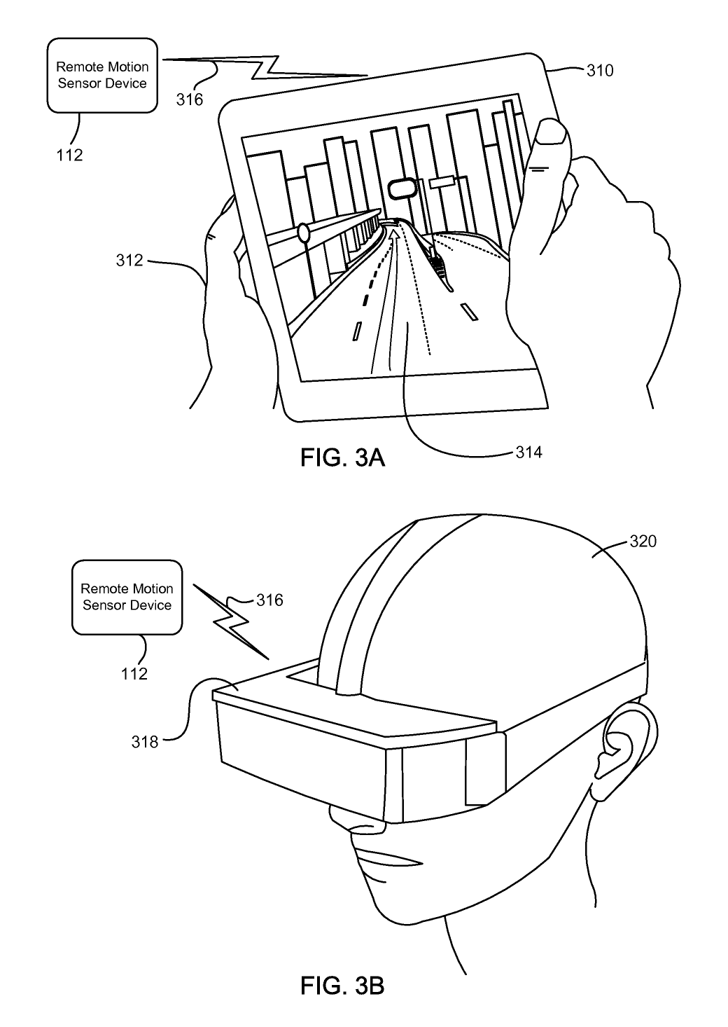

The mobile device 110 may be any device configured to receive user generated motion input. For example, FIG. 3A illustrates a handheld computer 310 (e.g., tablet) configured to receive user input through movement of a user's hands 312 according to one embodiment. In other words, the user's hands 312 may tilt, turn, rotate, and/or shake the handheld computer 310 to control actions or movement of a character in a video game, scroll through a document, open or close a software application, select a function of a software application, or provide other types of user input. In the illustrated example, the user controls a video game by turning the handheld computer 310 to steer a through the streets of a virtual city shown on a display device 314. The handheld computer 310 receives a wireless signal 316 from the remote motion sensor device 112 comprising at least the remote accelerometer sensor data 120 shown in FIG. 1. The handheld computer 310 is configured to generate the local accelerometer sensor data 118 shown in FIG. 1 in response to movement from the user's hands 312, and to subtract the remote accelerometer sensor data 120 from the local accelerometer sensor data 118 to compensate for movement imparted to the user by the vehicle 200 shown in FIG. 2, as described in certain embodiments herein.

The mobile device 110 shown is not limited to devices that receive input from a user's hands. For example, FIG. 3B illustrates virtual reality (VR) goggles 318 configured to receive user input through movement of a user's head 320 according to one embodiment. The user's head 320 may, for example, move left, right, up, or down to move through a displayed scene and/or scroll through a document. As in the previous example, the VR goggles 318 receives a wireless signal 316 from the remote motion sensor device 112 comprising at least the remote accelerometer sensor data 120 shown in FIG. 1. The VR goggles 318 includes circuitry configured to generate the local accelerometer sensor data 118 shown in FIG. 1 in response to movement from the user's head 320, and to subtract the remote accelerometer sensor data 120 from the local accelerometer sensor data 118 to compensate for movement imparted to the user by the vehicle 200 shown in FIG. 2, as described in certain embodiments herein. In certain embodiments, a single remote motion sensor device 112 may provide the wireless signal 316 to any number of users within the vehicle 200, including a first user controlling the handheld computer 310 shown in FIG. 3A and a second user controlling the VR goggles 318 shown in FIG. 3B.

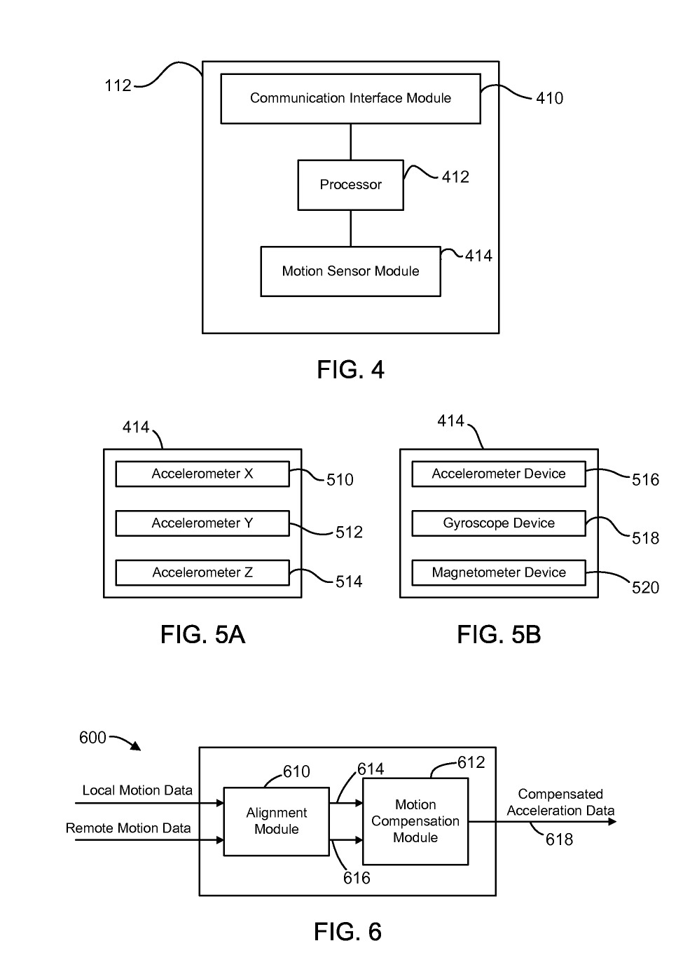

FIG. 4 is a block diagram of a remote motion sensor device 112 according to one embodiment. The remote motion sensor device 112 shown in FIG. 4 includes a communication interface module 410, a processor 412, and a motion sensor module 414. The processor 412 communicates with the communication interface module 410 and the motion sensor module 414, and may execute instructions to perform the functions described herein. In certain embodiments, the remote motion sensor device 112 includes a SoC that integrates one or more functions of the communication interface module 410, the processor 412, the motion sensor module 414, and/or other functions such as display, memory and/or power control.

The communication interface module 410 may include any wired and/or wireless communication device for providing the remote accelerometer sensor data 120 to the mobile device 110. The communication interface module 410 may include, for example, a universal serial bus (USB) driver or any other serial or parallel communication port. In addition, or in other embodiments, the communication interface module 410 may include a radio communication subsystem for wireless communications, such as a Bluetooth or WiFi radio.

The motion sensor module 414 includes one or more accelerometers. For example, FIG. 5A is a block diagram of a motion sensor module 414 according to one embodiment including an x-axis accelerometer 510, a y-axis accelerometer 512, and a z-axis accelerometer 514. Other embodiments may include only two accelerometers, or only one accelerometer. In certain embodiments, the accelerometers 510, 512, 514 may include, for example, any type of accelerometer designed for use with smartphones, tablets, digital audio players, personal digital assistants, digital cameras, and other electronic devices configured to generate movement-related parameter information such as acceleration and/or velocity.

In certain embodiments, the motion sensor module 414 includes one or more sensors in addition to accelerometers. For example, FIG. 5B is a block diagram of a motion sensor module 414 according to one embodiment including an accelerometer device 516, a gyroscope device 518, and a magnetometer device 520. The accelerometer device 516 may include one or more of the accelerometers 510, 512, 514 shown in FIG. 5A. The gyroscope device 518 may be configured to provide yaw, pitch, and/or rate and roll orientation parameters. The gyroscope device 518 may include, for example, a micro-electro-mechanical systems (MEMS) gyroscope such as those used in smartphones, tablets, and other electronic devices. The magnetometer device 520 may be configured to provide heading or compass direction parameter information and may also be of the type of magnetometers used in smartphones, tablets, and other electronic devices. In some embodiments, the gyroscope device 518 may be implemented without the magnetometer device 520, and vice versa. In other embodiments, the functionality of the gyroscope device 518 and the magnetometer device 520 may be combined or integrated. One or both of the gyroscope device 518 and the magnetometer device 520 may be used after an initial alignment, for example, to track changes in the orientation of the mobile device 110 with respect to the remote motion sensor device 112. In other embodiments, tracking changes in orientation is performed using only gyroscope and/or magnetometer devices located in the mobile device 110.

Returning to FIG. 4, persons skilled in the art will recognize from the disclosure herein that the remote motion sensor device 112 may include other components or modules (not shown), such as a battery, display device, keyboard or other user input device, and/or memory device. In certain embodiments, the remote motion sensor device 112 is a standalone unit configured to detect acceleration and/or other motion. For example, the motion sensor device 112 may be a portable sensor device that a user may permanently install the remote motion sensor device 112 in the user's vehicle or carry the remote motion sensor device 112 from vehicle to vehicle (from car to train to bus) for use during the user's commute. In other embodiments, one or more components and/or functions of the remote motion sensor device 112 may be integrated with a vehicle's system. A vehicle's onboard computer may execute instructions to perform one or more (or all) of the functions described herein for the remote motion sensor device 112, motion sensors installed at one or more vehicle locations (e.g., used for the vehicle's automatic collision notification system) may detect vehicle motion, and the vehicle's WiFi system may communicate the vehicle's motion data to one or more user devices authorized to access the WiFi system. For example, an airline may provide acceleration and/or other motion data from existing aircraft sensors to first class or business class passengers, to passengers who pay extra for the service, and/or to all passengers with WiFi access.

FIG. 6 is a block diagram of an accelerometer module 600 according to one embodiment. The accelerometer module 600 may be used, for example, as part of the accelerometer driver 114 in the mobile device 110 shown in FIG. 1. The accelerometer module 600 includes an alignment module 610 and a motion compensation module 612. The alignment module 610 is configured to receive local motion data from one or more sensors of the mobile device 110 and remote motion data from the remote motion sensor device 112. The local motion data and the remote motion data each include acceleration data, as discussed herein.

The alignment module 610 is configured to align a coordinate system of the mobile device 110 and a coordinate system of the remote motion sensor device 112.

The alignment module 610 may perform an initial alignment process that includes, for example, requesting a user to move the mobile device 110 in a first direction in a horizontal plane (e.g., along an estimated x-axis direction of the remote motion sensor device 112), and then to move the mobile device 110 in a second direction in the horizontal plane (e.g., along an estimated y-axis direction of the remote motion sensor device 112 that is perpendicular to the x-axis). The alignment module 610 may then use its acceleration data generated during the movement in the first direction and the second direction to establish an initial orientation of the mobile device 110 with the coordinate system of the remote motion sensor device 112. In certain embodiments, local motion data received by the alignment module 610 includes data provided by a gyroscope device and/or a magnetometer device of the mobile device 110. In such embodiments, the alignment module 610 is configured to track the orientation of the mobile device 110 with respect to the initial orientation corresponding to the coordinate system of the remote motion sensor device 112. Thus, the user can shift positions within a seat, or even change seats or locations within a vehicle, without realigning the user's mobile device 110 with the remote motion sensor device 112.

The alignment module 610 provides aligned local acceleration data 614 and remote acceleration data 616 to the motion compensation module 612. As discussed above, when the user and mobile device 110 are located in a moving vehicle monitored by the remote motion sensor device 112, the local acceleration data 614 includes a superposition of intended user input accelerations and unintended accelerations to the moving vehicle. The unintended accelerations appear as noise corresponding to the remote acceleration data. To remove the noise, the motion compensation module 612 is configured to subtract the remote acceleration data 616 from the local acceleration data 614 through, for example, the use of digital audio signal noise cancelation techniques.

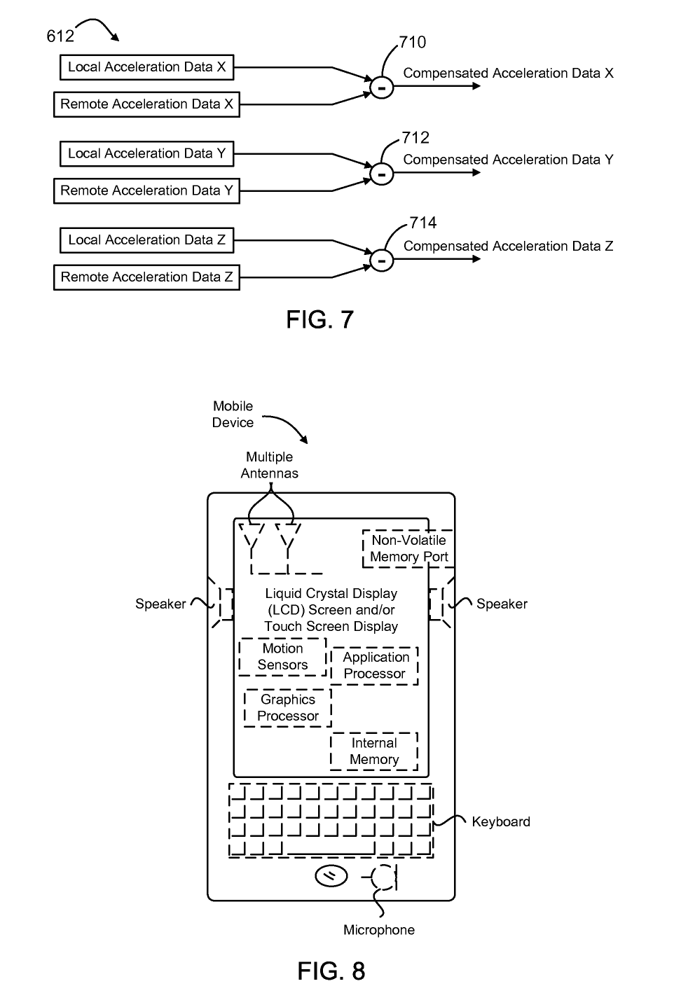

For example, FIG. 7 is a block diagram of a motion compensation module 612 according to one embodiment. The motion compensation module 612 includes a first subtraction module 710 corresponding to an aligned x-axis of the mobile device 110 and remote motion sensor device 112, a second subtraction module 712 corresponding to an aligned y-axis of the mobile device 110 and remote motion sensor device 112, and a third subtraction module 714 corresponding to an aligned z-axis of the mobile device 110 and remote motion sensor device 112. Instead of subtracting, skilled persons will recognize from the disclosure herein that each subtraction module 710, 712, 714 may be configured to invert a first signal (remote) and add it to a second signal (local). The first subtraction module 710 subtracts remote acceleration data X from local acceleration data X to generate compensated acceleration data X (corresponding to an x-axis). The second subtraction module 712 subtracts remote acceleration data Y from local acceleration data Y to generate compensated acceleration data Y (corresponding to a y-axis). The third subtraction module 714 subtracts remote acceleration data Z from local acceleration data Z to generate compensated acceleration data Z (corresponding to a z-axis).

The compensated acceleration data signal 618 shown in FIG. 6, (corresponding to the compensated acceleration data X, the compensated acceleration data Y, and the compensated acceleration data Z shown in FIG. 7) has less noise than that of the uncompensated acceleration signal provided by the mobile device's accelerometer. Thus, the accelerometer module 600 on the mobile device 110 presents software applications with a data stream that more accurately reflects the user's intended input, e.g., as if the user and the mobile device 110 were not undergoing unintended acceleration. The user's experience (e.g., game play or other interaction with the mobile device 110) is improved due to the enhanced noise immunity.

FIG. 8 is an example illustration of a mobile device that may be used according to certain embodiments, such as a user equipment (UE), a mobile station (MS), a mobile wireless device, a mobile communication device, a tablet, a handset, or another type of wireless communication device. The mobile device includes motion sensors, such as the x-axis accelerometer 510, the y-axis accelerometer 512, and the z-axis accelerometer 514 shown in FIG. 5A, and/or the accelerometer device 516, the gyroscope device 518, and the magnetometer device 520 shown in FIG. 5B. The mobile device can include one or more antennas configured to communicate with a transmission station, such as a base station, a base band unit, a remote radio head, a remote radio equipment, a relay station, a radio equipment, or another type of wireless wide area network (WWAN) access point. The mobile device can be configured to communicate using at least one wireless communication standard, including 3GPP LTE, WiMAX, high speed packet access, Bluetooth, and/or WiFi. The mobile device can communicate using separate antennas for each wireless communication standard or shared antennas for multiple wireless communication standards. The mobile device can communicate in a wireless local area network (WLAN), a wireless personal area network (WPAN), and/or a WWAN.

FIG. 8 also provides an illustration of a microphone and one or more speakers that can be used for audio input and output from the mobile device. The display screen may be a liquid crystal display (LCD) screen or other type of display screen, such as an organic light emitting diode (OLED) display. The display screen can be configured as a touch screen. The touch screen may use capacitive, resistive, or another type of touch screen technology. An application processor (configured to perform the functions described herein) and a graphics processor can be coupled to internal memory to provide processing and display capabilities. A non-volatile memory port can also be used to provide data input/output options to a user. The non-volatile memory port may also be used to expand the memory capabilities of the mobile device. A keyboard may be integrated with the mobile device or wirelessly connected to the mobile device to provide additional user input. A virtual keyboard may also be provided using the touch screen.

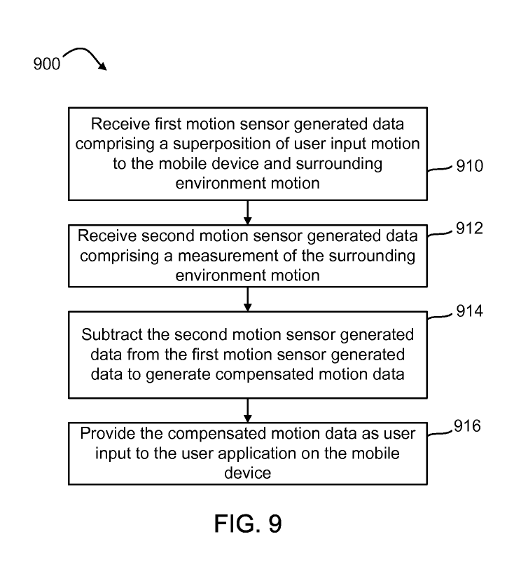

FIG. 9 is a flowchart of a method 900 for controlling a user application on a mobile device according to one embodiment. The method includes receiving 910 first motion sensor generated data comprising a superposition of user input motion to the mobile device and surrounding environment motion, receiving 912 second motion sensor generated data comprising a measurement of the surrounding environment motion, subtracting 914 the second motion sensor generated data from the first motion sensor generated data to generate compensated motion data, and providing 916 the compensated motion data as user input to the user application on the mobile device.

### Examples

The following are examples of further embodiments. Examples may include subject matter such as a method, means for performing acts of the method, at least one machine-readable medium including instructions that, when performed by a machine cause the machine to perform acts of the method, or of an apparatus or system for improving input to a mobile device according to the embodiments and examples described herein.

Example 1 is a system to improve user input to a mobile device. The system includes a remote motion sensor device configured to generate remote acceleration data corresponding to movement of a vehicle. The system also includes an accelerometer module configured to receive the remote acceleration data generated by the remote motion sensor, and to receive local acceleration data corresponding to movement of the mobile device. The accelerometer module includes a motion compensation module configured to subtract the remote acceleration data from the local acceleration data to generate compensated acceleration data. The accelerometer module is configured to provide the compensated acceleration data as user input to a software application on the mobile device.

Example 2 includes the subject matter of Example 1, wherein the remote motion sensor device includes a motion sensor module comprising at least one remote accelerometer to generate the remote acceleration data. The remote motion sensor may also include a communication interface module configured to transmit the remote acceleration data to a mobile device, and a processor to control at least one of the motion sensor module and the communication interface module.

Example 3 includes the subject matter of Example 2, wherein the at least one remote accelerometer includes a 3-axis accelerometer, and wherein the remote acceleration data indicates movement of the vehicle in an x-axis direction, a y-axis direction, and a z-axis direction of the 3-axis accelerometer.

Example 4 includes the subject matter of any of Examples 1-3, wherein the motion sensor module further comprises at least one of a gyroscope device and a magnetometer device.

Example 5 includes the subject matter of any of Examples 1-4, wherein the communication interface module is configured for serial communications with the mobile device over a communication wire.

Example 6 includes the subject matter of any of Examples 1-5, wherein the communication module comprises a wireless communication subsystem.

Example 7 includes the subject matter of any of Examples 1-6, wherein the accelerometer module further include an alignment module configured to align the remote acceleration data with the local acceleration data for processing by the motion compensation module. The alignment module may align the remote acceleration data with the location acceleration data by an alignment of a first coordinate system of the remote motion sensor with a second coordinate system of the mobile device.

Example 8 includes the subject matter of Example 7, wherein the alignment module is further configured to determine an initial orientation of the second coordinate system with respect to the first coordinate system, and to track deviations from the initial orientation based on at least one of local gyroscope data and local magnetometer data.

Example 9 includes the subject matter of any of Examples 1-8, wherein the motion compensation module is further configured to subtract the remote acceleration data from the local acceleration data using a digital audio signal noise cancelation algorithm.

Example 10 includes the subject matter of any of Examples 1-9, wherein the remote motion sensor comprises one or more mounting member selected from a group comprising a magnet, a clamp, a fastening member, and a weighted member.

Example 11 is a method for controlling a user application on a mobile device. The method includes receiving first motion sensor generated data comprising a superposition of user input motion to the mobile device and surrounding environment motion, receiving second motion sensor generated data comprising a measurement of the surrounding environment motion, subtracting the second motion sensor generated data from the first motion sensor generated data to generate compensated motion data, and providing the compensated motion data as user input to the user application on the mobile device.

Example 12 includes the subject matter of Example 11, wherein the first motion sensor generated data comprises a first acceleration waveform, the second motion sensor generated data comprises a second acceleration waveform. The subtracting may include inverting the second acceleration waveform to produce an inverted waveform, and adding the inverted waveform to the first acceleration waveform.

Example 13 includes the subject matter of any of Examples 11-12, and further includes aligning a first coordinate system of a local accelerometer in the mobile device with a second coordinate system of a remote accelerometer configured to measure the surrounding environment motion.

Example 14 includes the subject matter Example 13, and further includes determining an initial orientation of the first coordinate system with respect to the second coordinate system, and tracking deviations from the initial orientation.

Example 15 includes the subject matter of any of Examples 11-14, and further includes tracking the deviations based on at least one of gyroscope data and magnetometer data.

Example 16 includes the subject matter of any of Examples 11-15, wherein the subtracting comprises executing a digital audio signal noise cancelation algorithm.

Example 17 is at least one computer-readable storage medium having stored thereon, the instructions when executed on a machine cause the machine to perform the method of any of Examples 11-16.

Example 18 is an apparatus comprising means to perform the method in any of Examples 11-16.

Example 19 is at least one computer-readable storage medium having stored thereon instructions that, when executed by a processor, cause the processor to perform operations including receiving first motion sensor generated data comprising a superposition of user input motion to the mobile device and surrounding environment motion, receiving second motion sensor generated data comprising a measurement of the surrounding environment motion, subtracting the second motion sensor generated data from the first motion sensor generated data to generate compensated motion data, and providing the compensated motion data as user input to the user application on the mobile device.

Example 20 includes the subject matter of Example 19, wherein the first motion sensor generated data comprises a first acceleration waveform, the second motion sensor generated data comprises a second acceleration waveform, and the subtracting includes inverting the second acceleration waveform to produce an inverted waveform and adding the inverted waveform to the first acceleration waveform.

Example 21 includes the subject matter of any of Examples 19-20, the operations further comprising aligning a first coordinate system of a local accelerometer in the mobile device with a second coordinate system of a remote accelerometer configured to measure the surrounding environment motion.

Example 22 includes the subject matter of any of Examples 19-21, the operations further comprising determining an initial orientation of the first coordinate system with respect to the second coordinate system; and tracking deviations from the initial orientation.

Example 23 includes the subject matter of Example 22, the operations further comprising tracking the deviations based on at least one of gyroscope data and magnetometer data.

Example 24 includes the subject matter of any of Examples 19-23, wherein the subtracting comprises executing a digital audio signal noise cancelation algorithm.

Example 25 is a portable motion sensor device including means for affixing the portable motion sensor device to a vehicle, a processor, and a motion sensor module communicatively coupled to the processor. The motion sensor may include at least one accelerometer to generate acceleration data. The portable motion system may further include a communication interface module communicatively coupled to the processor. The communication interface module configured to selectively establish a communication link with a mobile device and to transmit the acceleration data to the mobile device.

Example 26 includes the subject matter of Example 25, wherein the means for temporarily affixing comprises one or more of a magnet, a clamp, a fastening member, a weighted member, and/or other device for temporarily or permanently affixing the portable motion sensor device to a vehicle.

Example 27 includes the subject matter of any of Examples 25-26, wherein the at least one remote accelerometer comprises a 3-axis accelerometer, and wherein the remote acceleration data indicates movement of the vehicle in an x-axis direction, a y-axis direction, and a z-axis direction of the 3-axis accelerometer.

Example 28 includes the subject matter of any of Examples 25-27, wherein the motion sensor module further comprises at least one of a gyroscope device and a magnetometer device.

Example 29 includes the subject matter of any of Examples 25-28, wherein the communication interface module is configured for serial communications with the mobile device over a communication wire.

Example 30 includes the subject matter of any of Examples 25-29, wherein the communication module comprises a wireless communication subsystem.

Example 31 is a system to improve user input to a mobile device, and optionally includes any of: means for providing remote acceleration data; means for communicating the remote acceleration to a local device; means for aligning, at the local device, the remote acceleration data with local acceleration data; means for subtracting, at the local device, the remote acceleration data from the local acceleration data to generate compensated motion data; and means for providing the compensated motion data to a user application on the local device.

Example 32 includes the subject matter of Example 31, either including or omitting any optional features, and further including, means for providing remote gyroscope data. The means for communicating the remote acceleration data in Example 32 may further communicate the remote gyroscope data to the remote device. In addition, the means for aligning uses the gyroscope data may track deviations from an initial orientation with respect to the local device.

Example 33 includes the subject matter of any of Examples 31-32, and further includes means for affixing the portable motion sensor device to a vehicle.

Example 34 includes the subject matter of Example 33, wherein the means for affixing comprises one or more of a magnet, a clamp, a fastening member, and a weighted member.

The above description provides numerous specific details for a thorough understanding of the embodiments described herein. However, those of skill in the art will recognize that one or more of the specific details may be omitted, or other methods, components, or materials may be used. In some cases, well-known features, structures, or operations are not shown or described in detail.

Furthermore, the described features, operations, or characteristics may be arranged and designed in a wide variety of different configurations and/or combined in any suitable manner in one or more embodiments. Thus, the detailed description of the embodiments of the systems and methods is not intended to limit the scope of the disclosure, as claimed, but is merely representative of possible embodiments of the disclosure. In addition, it will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments may also be provided as a computer program product including a computer-readable storage medium having stored instructions thereon that may be used to program a computer (or other electronic device) to perform processes described herein. The computer-readable storage medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of medium/machine-readable medium suitable for storing electronic instructions.

As used herein, a software module or component may include any type of computer instruction or computer executable code located within a memory device and/or computer-readable storage medium. A software module may, for instance, comprise one or more physical or logical blocks of computer instructions, which may be organized as a routine, program, object, component, data structure, etc., that performs one or more tasks or implements particular abstract data types. In certain embodiments, the described functions of all or a portion of a software module (or simply “module”) may be implemented using circuitry.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be understood by those having skill in the art that many changes may be made to the details of the above-described embodiments without departing from the underlying principles of the invention. The scope of the present invention should, therefore, be determined only by the following claims.

1. A system to improve user input to a mobile device, the system comprising:
a remote motion sensor device configured to generate remote acceleration data corresponding to movement of a vehicle; and
an accelerometer module configured to receive the remote acceleration data generated by the remote motion sensor, and to receive local acceleration data corresponding to movement of the mobile device, the accelerometer module comprising:
a motion compensation module configured to subtract the remote acceleration data from the local acceleration data to generate compensated acceleration data,
wherein the accelerometer module is configured to provide the compensated acceleration data as user input to a software application on the mobile device.

2. The system of claim 1, wherein the remote motion sensor device comprises:
a motion sensor module comprising at least one remote accelerometer to generate the remote acceleration data;
a communication interface module configured to transmit the remote acceleration data to a mobile device; and
a processor to control at least one of the motion sensor module and the communication interface module.

3. The system of claim 2, wherein the at least one remote accelerometer comprises a 3-axis accelerometer, and wherein the remote acceleration data indicates movement of the vehicle in an x-axis direction, a y-axis direction, and a z-axis direction of the 3-axis accelerometer.

4. The system of claim 2, wherein the motion sensor module further comprises at least one of a gyroscope device and a magnetometer device.

5. The system of claim 2, wherein the communication interface module is configured for serial communications with the mobile device over a communication wire.

6. The system of claim 2, wherein the communication module comprises a wireless communication subsystem.

7. The system of claim 1, wherein the accelerometer module further comprises:
an alignment module configured to align the remote acceleration data with the local acceleration data for processing by the motion compensation module, the alignment module to align the remote acceleration data with the location acceleration data by an alignment of a first coordinate system of the remote motion sensor with a second coordinate system of the mobile device.

8. The system of claim 7, wherein the alignment module is further configured to determine an initial orientation of the second coordinate system with respect to the first coordinate system, and to track deviations from the initial orientation based on at least one of local gyroscope data and local magnetometer data.

9. The system of claim 1, wherein the motion compensation module is further configured to subtract the remote acceleration data from the local acceleration data using a digital audio signal noise cancelation algorithm.

10. A method for controlling a user application on a mobile device, the method comprising:
receiving first motion sensor generated data comprising a superposition of user input motion to the mobile device and surrounding environment motion;
receiving second motion sensor generated data comprising a measurement of the surrounding environment motion;
subtracting the second motion sensor generated data from the first motion sensor generated data to generate compensated motion data; and
providing the compensated motion data as user input to the user application on the mobile device.

11. The method of claim 10, wherein the first motion sensor generated data comprises a first acceleration waveform, the second motion sensor generated data comprises a second acceleration waveform, and the subtracting comprises:
inverting the second acceleration waveform to produce an inverted waveform; and
adding the inverted waveform to the first acceleration waveform.

12. The method of claim 10, further comprising aligning a first coordinate system of a local accelerometer in the mobile device with a second coordinate system of a remote accelerometer configured to measure the surrounding environment motion.

13. The method of claim 12, further comprising:
determining an initial orientation of the first coordinate system with respect to the second coordinate system; and
tracking deviations from the initial orientation.

14. The method of claim 13, further comprising tracking the deviations based on at least one of gyroscope data and magnetometer data.

15. The method of claim 10, wherein the subtracting comprises executing a digital audio signal noise cancelation algorithm.

16. At least one computer-readable storage medium having stored thereon instructions that, when executed by a processor, cause the processor to perform operations comprising:
receiving first motion sensor generated data comprising a superposition of user input motion to the mobile device and surrounding environment motion;
receiving second motion sensor generated data comprising a measurement of the surrounding environment motion;
subtracting the second motion sensor generated data from the first motion sensor generated data to generate compensated motion data; and
providing the compensated motion data as user input to the user application on the mobile device.

17. The least one computer-readable storage medium of claim 16, wherein the first motion sensor generated data comprises a first acceleration waveform, the second motion sensor generated data comprises a second acceleration waveform, and the subtracting comprises:
inverting the second acceleration waveform to produce an inverted waveform; and
adding the inverted waveform to the first acceleration waveform.

18. The least one computer-readable storage medium of claim 16, the operations further comprising aligning a first coordinate system of a local accelerometer in the mobile device with a second coordinate system of a remote accelerometer configured to measure the surrounding environment motion.

19. The least one computer-readable storage medium of claim 18, the operations further comprising:
determining an initial orientation of the first coordinate system with respect to the second coordinate system; and
tracking deviations from the initial orientation.

20. The least one computer-readable storage medium of claim 19, the operations further comprising tracking the deviations based on at least one of gyroscope data and magnetometer data.

21. The least one computer-readable storage medium of claim 16, wherein the subtracting comprises executing a digital audio signal noise cancelation algorithm.

22. A portable motion sensor device, comprising:
means for affixing the portable motion sensor device to a vehicle;
a processor;
a motion sensor module communicatively coupled to the processor, the motion sensor comprising at least one accelerometer to generate acceleration data; and
a communication interface module communicatively coupled to the processor, the communication interface module configured to selectively establish a communication link with a mobile device and to transmit the acceleration data to the mobile device.

23. The portable motion sensor device of claim 22, wherein the means for affixing comprises a temporary means for affixing including one or more of a magnet, a clamp, a fastening member, and a weighted member.

24. The portable motion sensor device of claim 22, wherein the at least one remote accelerometer comprises a 3-axis accelerometer, and wherein the remote acceleration data indicates movement of the vehicle in an x-axis direction, a y-axis direction, and a z-axis direction of the 3-axis accelerometer.

25. The portable motion sensor device of claim 22, wherein the motion sensor module further comprises at least one of a gyroscope device and a magnetometer device.
